(19) United States
(12) Patent Application Publication
(10) Pub. No.: US 2023/0144925 A1
(43) Pub. Date: May 11, 2023

(54) A METHOD OF MANUFACTURING A DISCRETIZED OPTICAL SECURITY MICROSTRUCTURE ON A SUBSTRATE AND A SHIM FOR USE IN THE METHOD

(71) Applicant: PENTACOMP PTE. LTD., Singapore (SG)

(72) Inventor: LIBOR KOTACKA, VELKA BITES (CZ)

(73) Assignee: NWM RESEARCH SP. Z O.O. SP. K., Warszawa (PL)

(21) Appl. No.: 17/916,095

(22) PCT Filed: Feb. 8, 2021
(86) PCT No.: PCT/EP2021/052976

§ 371 Date: Sep. 30, 2022

(30) Foreign Application Priority Data
Mar. 31, 2020 (EP) 20461524.9

(51) Int. Cl. B41M 3/14

(52) U.S. Cl. CPC B41M 3/14; B42D 25/324

(57) ABSTRACT

Manufacturing a discretized optical security microstructure on a substrate includes providing an ink into one or more cavities of a shim, the one or more cavities of the shim represent the discretized optical security microstructure, pressing the shim against the substrate, and removing the shim from the substrate. The shim is removed from the substrate such that the ink remains on a surface of the substrate forming the discretized optical security microstructure.

The shim includes a number of cavities. The characteristic size of an individual cavity is from 80 μm to 50 cm and the depth is from 300 nm to 100 μm. The cavities of the shim represent a discretized optical security microstructure representing diffractive or another optically active surface, preferably in a form of macro and/or micro relief, or simply curved shape with or without grating/hologram micro relief.

### FIELD

The aspects of the disclosed embodiments relate to a field of securing against counterfeiting things such as documents or money. The aspects of the disclosed embodiments relate particularly to a manufacturing of a discretized optical security microstructure.

### BACKGROUND

Document U.S. Pat. No. 10,300,732B2 discloses an anti-counterfeiting structure includes an allochroic layer including an allochroic part having a characteristic of changing from a first material to a second material in response to laser irradiation, a first layer transmissible to a laser beam, a second layer transmissible to the laser beam, at least a part of the second layer being located between the allochroic layer and the first layer, and a coating layer transmissible to the laser beam and covering at least the first layer. The coating layer and the first layer are bonded together more weakly than the first layer and the second layer are. One of the first layer and the second layer is a foamable layer having a characteristic of changing from an unfoamed state to a foamed state in response to laser irradiation, while the other of the first layer and the second layer is an optical device.

Document U.S. Pat. No. 9,618,839B2 discloses a method for the replication of a patterned surface relief microstructure, comprising the steps of generation of a first layer with a patterned surface relief microstructure, generation of a master, by copying the microstructure of the first layer into a second layer, thereby involving at least one dry or wet etching step, characterized by an additional step, in which the microstructure of the master is brought into contact with a replica material, such that the microstructure of the master is reproduced in the replica. The invention further relates to the elements made as a replica according to the method. The surface relief microstructures are suitable to display images with a positive-negative and/or color image flip. The elements according to the invention are particularly useful for securing documents and articles against counterfeiting and falsification.

Contrary to the aforementioned inventions, novel features are proposed, like the microstructure with different sub-microstructures, where at least one element comprises some kind of DOVID and/or holographic or other spatially modulated surface, what is not mentioned in that document. Further, U.S. Pat. No. 9,618,839B2 mentions final print on a form of remaining the printed ink or other material, on the surface, however our invention considered the discrete elements printed only, however where now relief replicated the substrate stays untouched. Furthermore, the details of the microrelief described in our invention are of much finer nature. Thus the U.S. Pat. No. 9,618,839B2 cannot offer answers to many embodiments of the present invention, like the production of the microrelief cannot be achieved by that US application, for example the microrelief of sizes equal and close to diffractive structure, could not be achieved via etching for some 1 micron or rather 10 um depths.

Document US 2008/0024846 discloses a process for the production of a multi-layer body comprising a first layer which is formed from micro-optical structures and which at least partially covers over one or more further layers having image regions and/or effect regions which produce an optical effect, wherein the micro-optical structures are arranged in register relationship with the image regions and/or effect regions. The micro-optical structures as well as the image regions and/or effect regions are applied by means of intaglio printing. There are also described a multi-layer body produced with that process and a security document having that multi-layer body.

The invention disclosed in US 2008/0024846 is devoted to the complicated multi-layer structure being situated on a substrate with the help of an adhesive, wherein the present disclosure does not need an adhesive. Second, the only similar issue with the present disclosure is the intaglio printing, however the structures are printed as complete structure as per se, like 54g, 54h, etc. (CHG, holograms, tactile feature) what is only implicating a standard well known method of intaglio print and the present disclosure further elaborates such methods of intaglio print in more advanced way.

Document US20170028764A1 discloses a method for forming a surface relief microstructure, especially an optically variable image (an optically variable device) on a transparent or translucent substrate and a product obtainable using the method. A further aspect of the invention is the use for the prevention of counterfeit or reproduction of a document of value and a method of forming a coating showing an angle dependent color change. This document differs in that that ink used in this document has mechanical particles. Furthermore the whole process create large, singular layer with microstructures.

Document WO2010089399A1 discloses a method of forming a relief pattern as part of a layered structure and comprising, forming a relief pattern on the surface of a layer of the said structure and subsequently forming a protective fixing layer on at least part of the said relief pattern and serving to protect the underlying relief pattern during any subsequent processing of the said structure, and thereby also provides for a layered structure, generally comprising a substrate having a relief pattern formed on a surface of the substrate and wherein at least a portion of the said relief has been provided with a protective fixing layer serving to retain the characteristics of the relief pattern during any subsequent processing of the structure such as, for example, when forming a laminate structure with the relief pattern provided therein.

The method presented in WO2010089399A1 is a very effective solution and quite pioneering at that time, the method of production of the Difractive Optically Variable Image Device (DOVID) semi-finished substrates before the final lamination was somehow cumbersome. First, the hologram must have been overprinted during the manufacturing process, then coated by means of a vacuum deposition and finally washed to clean residual parts of the coating—hence protection—layer. This has apparently an impact on the total cost on such production, as well as being also somehow less effective while increased demand on the substrate consumption as a non negligible amount of waste. Finally, the method demanded relatively too many technological steps essentially increasing an appearance of printing errors, like missing, though tiny, parts of holograms, unwanted dirtiness or other undesired contamination in areas free of holograms and so on.

Document DE102008055960 discloses a method which involve embossing a nano-graver on a surface in recesses that are independent from each other, such that a male mold is provided. The surface is formed, which has a recessed pattern, and such metallic pattern is used to process an upper surface. The polymeric surface is placed on a preferred hard surface, such that the surface is sampled in an etching process. Independent claims are included for the following: a method, particularly a gravure printing method for using male mold or female mold; a device for use as a gravure printing press for executing a mold creating method; and a gravure printing mold for use in a device or in a gravure printing method.

Document DE102018104435A1 discloses a method for producing labels having a surface profile. The method comprising at least steps of applying a liquid printable and/or liquid coatable paint on a surface of an interim carrier web, wherein the surface of the interim carrier web has a surface profile a negative mold of a label surface profile to be formed, laminating or otherwise contacting a material web intended for forming a number of labels onto the surface of the interim carrier web provided with the lacquer and forming or at least completing a hardened lacquer layer having the label surface profile, grown on the surface of the material web, by still uncured lacquer between the surface of the interim Carrier web and its facing surface of the material web or at least in still uncured lacquer areas on the surface of the material web is hardened.

Document WO2010092392A1 discloses a method of producing a diffractive optical element comprises forming on a textured surface of a first substrate, a predetermined pattern of an ink including an activator for a metallisation reaction and one or more binders; causing or allowing the binder to solidify; applying a first adhesive layer on top on the solidified binder and activator; securing a second substrate to the adhesive layer; removing the second substrate with adhered solidified binder and activator from the first substrate; and forming a metal coating onto the activator-containing regions adhered to the second substrate.

### SUMMARY

The present disclosure describes the method of production eliminating many of those noneffective steps and merges advantageously some of those production steps into one step (or at least effectively minimise their number) in a specific configuration.

According to the aspects of the disclosed embodiments, the method of manufacturing a discretized optical security microstructure on a substrate comprises the steps of
a) providing an ink into one or more cavities of a shim, wherein said one or more cavities of the shim represent said discretized optical security microstructure,
b) pressing the shim against the substrate,
c) removing the shim from the substrate such that ink remains on a surface of the substrate, forming a discretized optical security microstructure.

Preferably the method comprises two steps of

a1) providing an ink onto a surface of a shim which comprises at least one cavity representing an element of the discretized optical security microstructure,

a2) removing excessing ink from the shim such that the ink remains in cavities.

Preferably the thickness z1 of the ink printed on the surface of the substrate is defined as a function f of the location on said surface:

z1=f(x,y),

wherein (x,y) are coordinates of a point on said surface and z1 is measured in the direction normal, perpendicular, to said surface.

Preferably the method further comprises the step of

d) hardening the discretized optical security microstructures.

Preferably at least one discretized optical security microstructure forms a lens, or a diffractive lens like structure, or other optical element.

Preferably the surface of the discretized optical security microstructures is an optically active surface, preferably in a form of macro and/or micro relief, or curved shape with or without grating/hologram micro relief.

Preferably the substrate is used, which comprises a discretized optical security microstructure or which is a discretized optical security microstructure.

Preferably the substrate comprises plastic or paper or the substrate is plastic or paper

Preferably ultraviolet light is used in the hardening step d).

Alternatively, preferably heat is used in the hardening step d).

Preferably the discretized optical security microstructures have the width and the length from 80 μm to 50 cm and depth from 300 nm to 100 μm. It should be noted that the aforesaid limitation of 50 cm is arbitrary. A discretized optical security microstructure having even larger size may be manufactured according to the present disclosure, if only such structure is needed for practical use.

Preferably the discretized optical security microstructures have at least two different heights or different surfaces.

Preferably the substrate, preferably after the hardening step d), is laminated as a sandwich structure, wherein the substrate is a first layer, a second layer is made of a polymer or a resin and wherein said discretized optical security microstructures are between the substrate and the second layer.

Preferably each discretized optical security microstructure is separated from other such discretized optical security microstructure. The separation distance may range from 1 μm to 50 cm, preferably from 30 μm to 10 cm, most preferably from 80 μm to 1500 μm. In practice, the separation distance is not limited be absolute numbers. Rather, it can be as large as the size of said discretized optical security microstructure.

Preferably the shim is placing at least one discretized optical security microstructure on a relief on a substrate.

Preferably said shim comprising a number of cavities, wherein said cavities of the shim represent a discretized optical security microstructure representing diffractive or another optically active surface, preferably in a form of macro and/or micro relief, or simply curved shape with or without grating/hologram micro relief, and wherein the characteristic size of individual cavity, such as its width and the length, is from 80 μm through several mm, several cm, up to several dozen cm and the depth of individual cavity is from 300 nm to 100 μm. The terms “width” and “length” used here should be understood broadly as referring to characteristic size of the cavities. This is because cavities may have irregular or sophisticated shapes, for which shapes it is difficult to precisely define the “width” and the “length”.

Preferably each cavity have different size and/or surface.

Preferably each cavity is separated from other cavities. The separation distance may range from 1 μm to 50 cm, preferably from 30 μm to 10 cm, most preferably from 80 μm to 1500 μm. The separation distance may range from cavities nearly touching one another—thus the separation distance being several μm to covering the entire document area, which can be as large as the shim. It is also possible that within the same shim some cavities are separated by a small distance, e.g. of several μm, while other cavities are separated by a larger distance, e.g. of several dozen cm.

Preferably the shim is made of preferably metal such as nickel.

Preferably the depth z2 of the cavity is defined as a function g of the location on the surface of the shim:

z2=g(x,y),

wherein (x,y) are coordinates of a point of a cavity surface and z2 is measured in the direction normal (perpendicular) to said surface.

Preferably said one or more cavities of the shim are a negative of said discretized optical security microstructure or are a positive of said discretized optical security microstructure.

### BRIEF DESCRIPTION OF DRAWINGS

The present disclosure will be described with respect to a figures, on which:

FIG. 1 shows schematically how microstructures are manufactured according to the present disclosure,

FIG. 2 shows microstructures made with the method according to the present disclosure,

FIG. 3, 4 show different shapes of cavities in the shim,

FIG. 5 presents different orientation of the manufactured microstructures,

FIG. 6 presents preferred an embodiment in which a relief of the microstructure is defined by a function,

FIG. 7 shows preferred an embodiment in which microstructures are further laminated,

FIG. 8 presents an embodiment in which the microstructure is placed on top of a relief on the substrate,

FIG. 9 presents an embodiment in which the microstructure is placed on top of a relief on the substrate and wherein there are different reliefs on top of the microstructure,

FIG. 10 shows an embodiment in which microstructures form optical elements,

FIG. 11 shows schematically some examples of the various micro-optical devices being able to print as separate features,

FIG. 12 depicts a variety and complexity of microstructures possibly printed using one shim,

FIG. 13 shows an alternative way of embossing the structure via modulating preprinted varnish,

FIG. 14 schematically presents various optical features achievable by the present disclosure, that is the relatively thin film interference structure and coating another pre-embossed microrelief,

FIG. 15 shows a possible way of printing various Moire and integral imaging structures, where there is a certain link spatially distributed images and the positions of the pattering lenses,

FIG. 16 shows a more complex of printing two different latent, but mutually linked coded structures yielding when overprinted,

FIG. 17 shows a possible structure for printing by the present disclosure, where two different features/colors C1, C2 are seamlessly displayed,

FIG. 18 shows further embodiment of the present disclosure is on the diagrammatic, where for example a combination of three different microstructures offers up to seven different patterns of otherwise distinguishable features,

FIG. 19 shows examples of printing kind of lenses over microstructures, simply adding an ink with substantially parallel, printing the microrelief elements as discrete objects, or printing diffractive relief over another diffractive relief,

FIG. 20 simply indicates several ways of printing single or multiple structures using the present disclosure.

### DETAILED DESCRIPTION

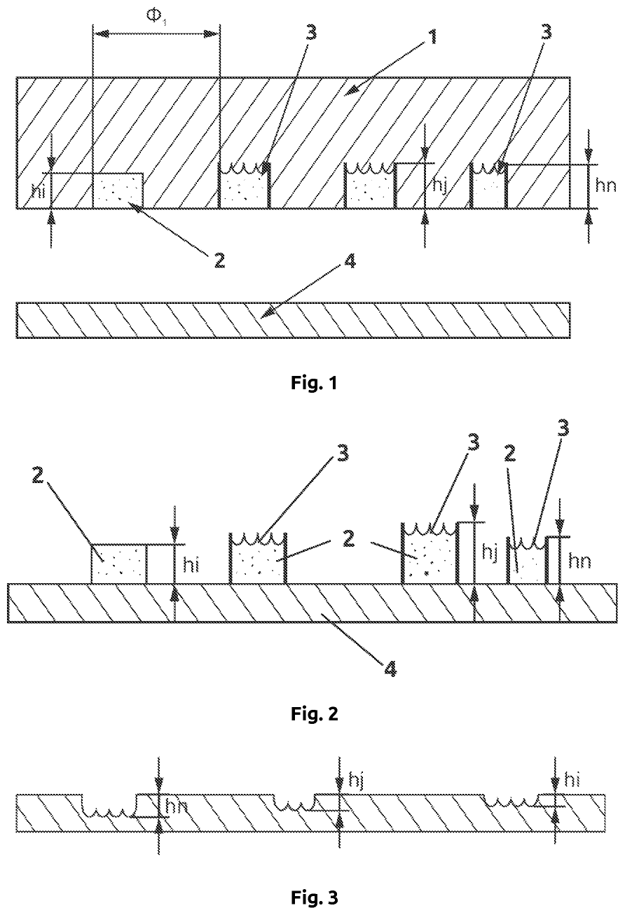

The method is schematically described in FIGS. 1 and 2. The embossing or printing shim 1s is made of preferably metal such as nickel Ni. However, there is no theoretical limit to the shim 1 material as it all should reflect the desired resolution and printing properties and technique of such shim 1. The shim 1 comprises at least one, preferably a number of structures, having diffractive or another optically “active” surface (in a form of macro and/or micro relief etc.) or simply curved shape with or without grating/hologram micro relief. The relief is to be directly transferred to the substrate 4 as for the hard embossing or, more importantly, could be used for the UV ink transfers, or any similar varnish assisted print, where the varnish is to be able to carry the desired micro relief from the shim 1 master, which is presented in FIGS. 3 and 4.

Preferably the substrate 4 comprises plastic or paper or the substrate 4 is plastic or paper.

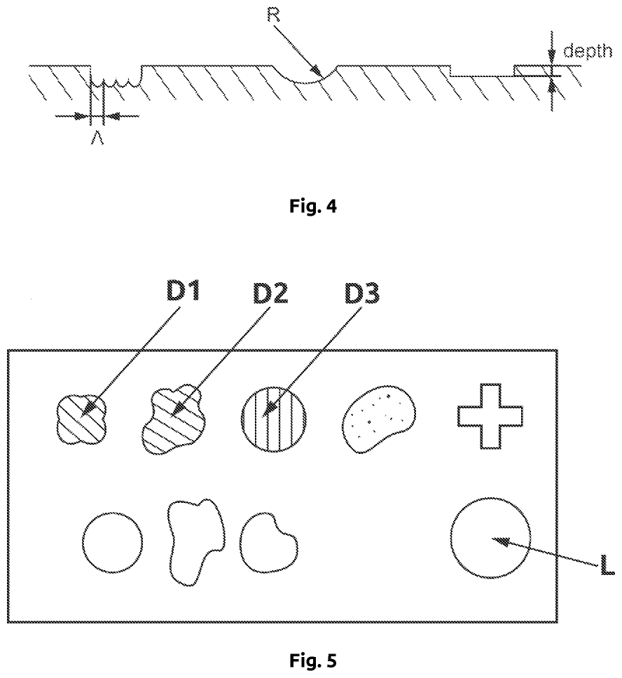

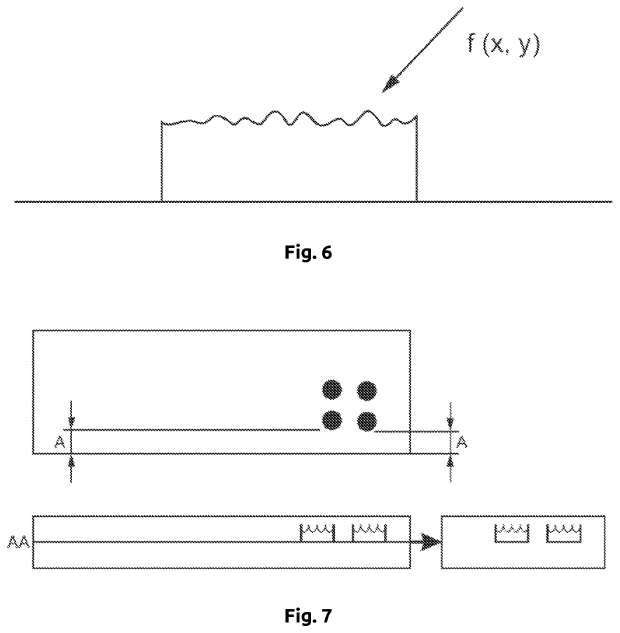

The elements may have any topology on the surface (lateral, x-y), more over each and every element may have a unique shape of its boundaries, even down to micrometer or even sub micrometer spatial resolution, as presented in FIG. 5. The boundary spatial/graphical resolution can be of any geometrical curve or an element, like a square, cross as on this figure, however it is worth noting the graphical resolution can be principally close to the resolution of the diffractive element, thus each grove and its physical ending can create a pertinent part of the element border.

As seen from FIG. 1, the depth of the relief may also be very unique for each, even single, particular surface element. The depth of the structure can even vary inside each particular element. A method according to the aspects of the disclosed embodiments comprises steps of
a) providing an ink into one or more cavities of a shim 1, wherein said one or more cavities of the shim represent said discretized optical security microstructure 2,
b) pressing the shim 1 against the substrate 4,
c) removing the shim 1 from the substrate 4 such that ink remains on a surface of the substrate 4, forming a discretized optical security microstructure 1.

Preferably the step a) of the method comprises two sub-steps

a1) providing an ink onto a surface of a shim 1 which comprises at least one cavity representing an element of the discretized optical security microstructure 2,

a2) removing excessing ink from the shim 1 such that the ink remains in cavities.

Then a given ink or varnish, preferably some UV (ultraviolet) or heat curable, but not limiting to this is used to transfer the “seed” elements onto the surface, what is shown in FIG. 2). In this embodiment the method preferably comprises an additional step d) being hardening the discretized optical security microstructures 2.

This can be used as a forensic feature, where the height, thus depth of the embossed grating can be analysed, or such element can yield another optical effect, where the effect is a function of the optical path and/or is based on a phase difference. Preferably the discretized optical security microstructures 2 have at least two different heights or different surfaces, as shown in FIG. 9. This can offer quite a number of vial patterns, like altering two colours etc. This embodiment of the present disclosure is to exploit some optical principles known from thin film optics. Advantageously one can print a layer being thin typically only several micrometer, say 1-10 um, where an internal interference may occur. Theoretically, each printed thin-film like element would offer a pertinent interference pattern thus a colour spectrum. As a function of the angle of the impinging (white) light and observed at a given angle.

FIG. 19 shows a possibility of combining different micro relief on other interface, while at least partly overlapping from the geometric aspect. For example, in FIG. 19a, the microlense(s) can be situated on top of the, preferably, diffractive elements on the substrate. Further, FIG. 19b-d, the two different diffractive structures can be used in other side, thus interface.

This method may be used to produce an image made of a plurality of microstructures, wherein each microstructure is placed in particular, designed place. With methods known from the prior art is difficult to create such images. The method according to the present disclosure provides solution to this problem while also being able to be used in a large-scale production, where the shim 1 has a cylindrical shape.

Preferably the discretized optical security microstructures 2 have the width and the length from 80 μm to several mm/cm pm and depth from 500 nm to 100 μm.

The lateral dimensions of each cavity have typical dimension from 80 μm to several millimeters, even perhaps cm, bur preferably somewhere between 0.3 mm to 2 mm. The heights h_1, . . . , h_j, . . . , h_n can vary typically, from 500 nm to 100 μm (typically 1 to 15 μm), however the limits may only depend on the used ink properties. Thus for certain applications the height may be even higher, say few hundreds micrometers. For diffractive structures, the period of gratings grooves, rather the typical sizes of the microelements for some computer generated structures of the micro-structured surface, corrugated surfaces is obviously from 0.3 μm to 100 μm, preferably between 1 μm to 30 μm. The amplitude of the microstructured surfaces is usually from 0.1 μm to 5 μm, for some lenses even up to 10-15 μm, here however this have to be carefully considered with the total depth of the cavity, obviously, the spacing between cavities can be from theoretically from 80 μm to, apparently, several centimeters, however typical spacing is from 0.3 mm to 1 mm. Thus Phi_1 is typically and visually more convenient within the range of 1-3.5 mm, though the limits are within the limits given above.

In yet another preferred embodiment each discretized optical security microstructure 2 is separated from other discretized optical security microstructure 2, preferably with a distance 100-1000 μm. In general, the separation distance may vary from 1 μm to 50 cm, preferably from 30 μm to 10 cm, most preferably from 80 μm to 1500 μm.

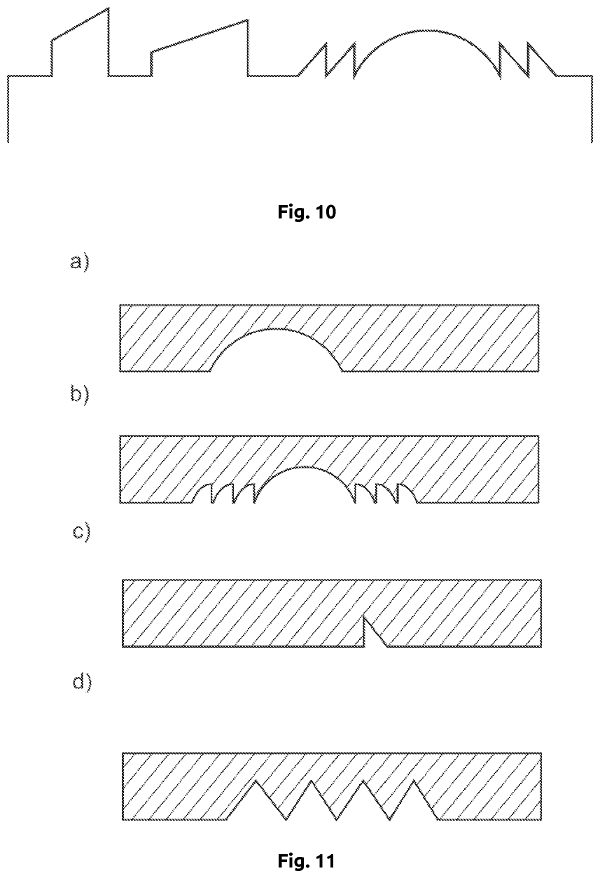

The complexity of the master manufacturing can be supported by a various recombination techniques otherwise being practically impossible or extremally difficult to be made using one origination technique. This will allow to have diffractive elements like gratings together with spatially modified surfaces like lenses, spherical, aspherical, rectangular shapes etc. and many variations amongst them—presented, as examples, in FIG. 10. Other examples of such optical embodiments are pyramids, also stepped pyramids like “Aztek pyramids”, non-spherical lenses, cylindrical lenses, hybrid diffractive-refractive lenses and similar elements, axicon.

In FIG. 11 there are several examples shims for manufacturing optical elements, that might be used. In FIG. 11a is presented a shim for a standard lens. In FIG. 11b is presented a shim for a diffractive lens. In FIG. 11c is presented a shim for a prism. In FIG. 11d is presented a shim for 3d pyramids, which size is much smaller than diffraction period, for example 0.5-3 mm.

Quite broad possibilities of the present disclosure are presented in FIG. 5. Where the particular elements can have nearly arbitrary shape or can be describe with a mathematical function z1=f(x,y), wherein (x,y) are coordinates of a point on said surface and z1 is measured in the direction normal, perpendicular, to said surface.

Further, for the case of pre-embossed relief and its overprint, the elements printed on top of it can be in a form of, for example, randomly distributed drops, where the random or pseudo-random distribution of the drops may carry some kind of information, most likely covert which is given by the coordinated of such drops etc. Moreover, some overprints having the shape of the so-called bar codes and/or QR codes and many similar are obvious. Such individual elements can offer a simple graphical motif or more motifs and can also be situated in a shape of, say, mosaic structure creating more complex pattern.

With respect to the previously cited prior art document WO 2010/089399, it is possible to extend that invention by adding another diffractive or related microscopic or microrelief structure to the top side of at least one element. In this embodiment the substrate 4 is used, which comprises a discretized optical security microstructure 2 or which is a discretized optical security microstructure 2. Therefore the surface of the discretized optical security microstructures 2 preferably is an optically active surface 3, preferably in a form of macro and/or micro relief, or curved shape with or without grating/hologram micro relief. Advantageously, it is possible to present a slightly, or on the other hand substantially, different optical feature in just a single element or in a demarcated group of several single elements.

This may be seen as at the independent, for example, diffractive structure or being somehow optically coupled as for example exploiting the so-called Moire effects of in general some way of integral imaging features. In other words, two or theoretically more coinciding spatial elements can be exploited not the whole security document in order to offer some visual pattern.

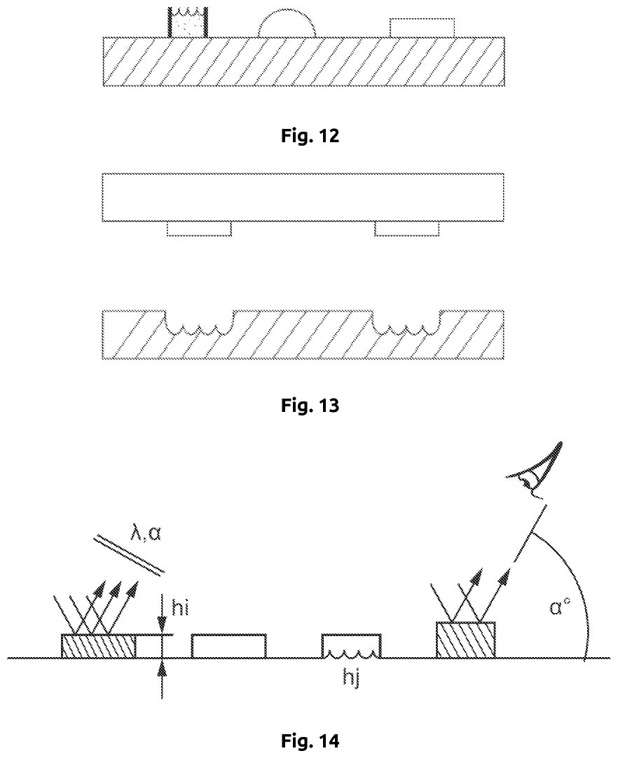

This can be easily observed by the naked eyes even on the layman way of the observation or it can serve as a forensic feature as well. Elements can be printed in a form of blade structures, prismatic ones, lenses, complex diffractive elements, covert laser readable features and so on. Such elements can offer some optical features as only sell standing or more importantly rather preferably in a form of acting in a group like for example the element Fresnel lenses, the so-called nano gravure features. Such features can be modified from the relief point of view in actually very general way. FIG. 12 shows that various microstructures 2 may be considered as self standing features on the substrate 4.

Another embodiment is a varnish overprinting to fix the relief except of full lamination with the identical (of different) material the full lamination like described in WO2010/089399. In that embodiment the substrate 4, preferably after the hardening step d), is laminated as a sandwich structure, wherein the substrate 4 is a first layer, a second layer is made of a polymer or a resin and wherein said discretized optical security microstructures 2 are between the substrate and the second layer. It is shown in FIG. 7. It should be noted that the ink should have at least minimally different refractive index contrast comparing to the substrate, if considered a lamination of the transparent substrates. The ink could contain colous, UV pigments, metallic particles, rather nano and microparticles.

Further, the over printing can pattern some structures being otherwise hidden or somehow encrypted in the substrate 4. It can advantageously be used to print/have the media in a form of polarization sensitive material, like liquid crystals etc., being organised according to the grating grooves orientation. It will also be very easy to achieve a bi-material, or in general multimaterial effects either in colour or in-combined diffractive effects within the printing and/or embossing possibilities or multiple print, kind of over prints or so, fairly unlimited in the printed area, also combination over WO 2010/089399 especially advantageous for multiple (two or more) materials etc. The only printed layer can be laser writable this can extend itself. For other applications, it may apply with a “reasonable parameters” with nearly no limits, using multiple print etc. As far as it is additional practically by conventional printing technology. Master can be engraved mechanically, microengraved with or without gratings, any microstructure 2 by e-beam, optical writing etc. etc., etched, mechanically processed, laser ablated or many suitable combinations among. Obviously, the particular printed elements can be of a different colours as much as possible to mix to the varnish.

FIG. 13 shows an embodiment in which microstructures are being embossed then eventually coated.

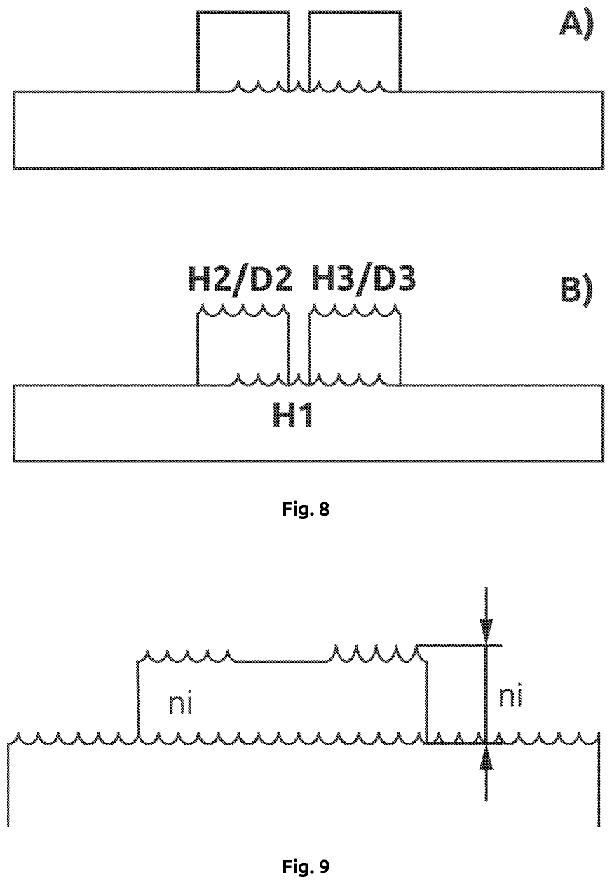

Preferably the shim 1 is placing at least one discretized optical security microstructure 2 on a relief on a substrate 4. It is shown in FIGS. 8 and 9. In FIG. 8a a microstructure comprises only one relief, which is on a substrate 4. In FIG. 8b there are two reliefs—one on microstructure 2 surface and other one on the surface of the substrate 4. The substrate 4 can carry some DOVID/holographic or similar micro modulated relief structure H1, while the upper part of the overprinted element can comprise other diffractive, holographic of other surface as describe on the present disclosure, H2/D2, H3/D3, wherein H1 is a first holographic structure, H2 is a second holographic structure, D2 is a second diffractive structure and D3 is a third diffractive structure, or any suitable combination among them.

A shim for use in the method comprising a number of cavities, wherein said cavities of the shim 1 represents a discretized optical security microstructure 2 representing diffractive or another optically active surface 3, preferably in a form of macro and/or micro relief, or simply curved shape with or without grating/hologram micro relief, and wherein the width and the length of individual cavity is from 80 μm through several mm, several cm, up to several dozen cm and the depth of individual cavity is from 300 nm to 100 μm. Preferably the shim is used in which each cavity have different size and/or surface. The terms “width” and “length” used here should be understood broadly as referring to characteristic size of the cavities. This is because cavities may have irregular or sophisticated shapes (see e.g. D1, D2 in FIG. 5), for which shapes it is difficult to precisely define the “width” and the “length”.

In the shim according to the present disclosure preferably in each cavity is separated from other cavities, preferably with a distance 100-1000 μm. In general, the separation distance may vary from 1 μm to 50 cm, preferably from 30 μm to 10 cm, most preferably from 80 μm to 1500 μm.

In a preferred embodiment a depth z2 of the cavity is defined as a function g of the location on said surface z2=g(x,y), wherein (x,y) are coordinates of a point of a cavity surface and z2 is measured in the direction normal (perpendicular) to said shim. Preferably one or more cavities of the shim 1 are a negative of said discretized optical security microstructure 2 or are a positive of said discretized optical security microstructure 2.

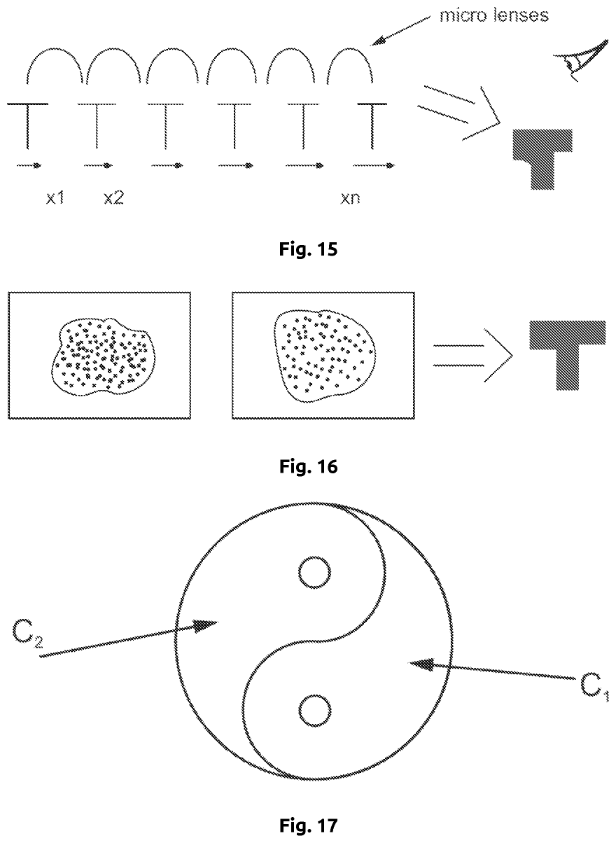

FIG. 14 shows a possible aspect of the disclosed embodiments when the layer thickness is considered. A specific thickness of the element being thus a transparent dielectric characterised by a refractive index n, eventually n_1, . . , n_j, . . . n_N. Following the theory of thin films reflection, such structure having a proper thickness and the refractive index can offer a colourful effect for a given angle of the observation. It can also be combined with diffractive interface and/or substrate to provide another optically attractive features.

FIG. 15 shows matching of two information from either side of the element, leading ultimately, but not restricted to, a Moire kind of effect, integral imaging or so. Simply, there is some microstructure with a spatial distribution given by their positions x1, x2, x3, . . . , xN with adequate distributed lens (or any displaying microstructure, or decoding element to the image patter) array. Ultimately, this may offer some (preferably) eye visible pattern, e.g. a letter “T” or any other designed shape.

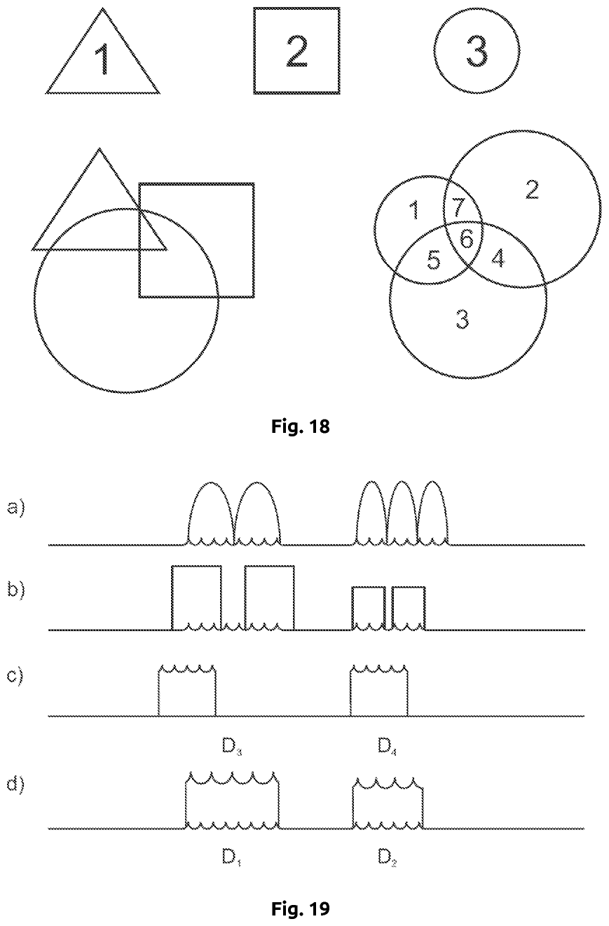

FIG. 16 shows schematically an embodiment, where the substrate interface carries some kind of coded image, and the upper surface/interface serves as the decoding element for this kind of integral or similar related imaging.

FIG. 17 shows two or more substantially different structure of different properties and parameters in one complex image.

FIG. 18 shows yet another aspect of the disclosed embodiments. In this embodiment three unitary, even monothematic elements can be combined in one complex image advantageously combining their properties, emphasizing or on the other hand eliminating their optical properties (crossing grains, polarization properties, constructive vs. destructive interference and so on). Ultimately, three (3 as an example for the sake of simplicity with no practical limits) different single elements can be partially overprinted, offering thus 7 different features based on this sample, features 1, 2,3, 1+2,1+3, 2+3,1+2+3.

FIG. 19a shows that the embossed microrelief 2 can be positioned on the top surface bearing any other most likely printed or laser engraved patterns. On the other hand, one can consider a method of overprinting the relief from the rear side of the substrate, where the diffractive structure can be the so-called hard or soft embossed or printed by any similar UV assisted technique. There can be just one of more than two elements in a form of localized thin film discrete elements emphasizing the desired optical phenomena, as shown in FIG. 19b. Obviously, the pattern can be free of diffractive elements, as shown in FIG. 19c on the left or even such an element, in general, with or without the micro relief overprinted with another element in the shape of lenses or any 3D defined element. This is further elaborate in a shape of kind of building blocks in this figure, such as in FIG. 19d, where each element can bear a different optical properties, e.g. colour of the ink, refractive index or even such property can vary inside at least one particular element.

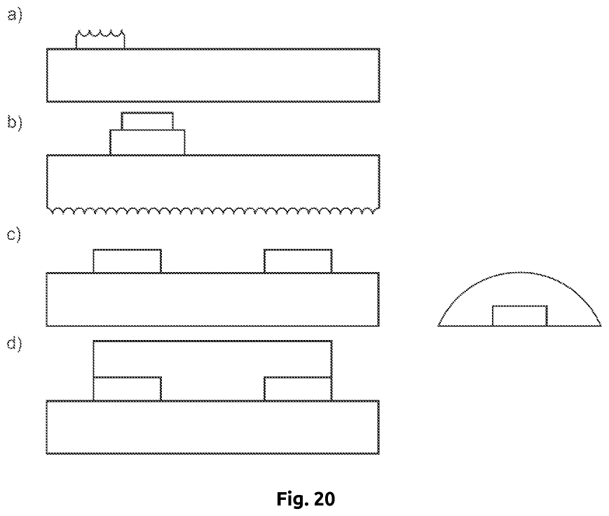

FIG. 20 shows the possible variations how the present disclosure can be exploited as a single print with diffractive microstructure, two overlapping prints with, for example, different colour with another pre-embossed grating on the substrate, rectangular element (even with relief—omitted on the figure for the simplicity) and overprinted with some curved surface, or the simples case of multi-object prints.

1. A method of manufacturing a discretized optical security microstructure on a substrate comprising steps of:
a) providing an ink into one or more cavities of a shim, wherein said one or more cavities of the shim represent said discretized optical security microstructure,
b) pressing the shim against the substrate,
c) removing the shim from the substrate
wherein the step c) the shim is removed from the substrate such that the ink remains on a surface of the substrate forming a discretized optical security microstructure.

2. The method according to claim 1, wherein the method comprises two step of
a1) providing an ink onto a surface of a shim which comprises at least one cavity representing an element of the discretized optical security microstructure,
a2) removing excessing ink from the shim such that the ink remains in cavities.

3. The method according to claim 1, wherein the thickness z1 of the ink printed on the surface of the substrate is defined as a function f of the location on said surface:
z1=f(x,y),
wherein (x,y) are coordinates of a point on said surface and z1 is measured in the direction normal, perpendicular, to said surface.

4. The method according to claim 1, wherein the method further comprises the step of
d) hardening the discretized optical security microstructures.

5. The method according to claim 1, wherein at least one discretized optical security microstructure forms a lens, or a diffractive lens like structure, or other optical element.

6. The method according to claim 1, wherein the surface of the discretized optical security microstructures is an optically active surface, preferably in a form of macro and/or micro relief, or curved shape with or without grating/hologram micro relief.

7. The method according to claim 1, wherein the substrate is used, which comprises a discretized optical security microstructure or which is a discretized optical security microstructure.

8. The method according to claim 1, werein the substrate comprises plastic or paper or the substrate is plastic or paper

9. The method according to claim 4, wherein ultraviolet light is used in the hardening step d).

10. The method according to claim 1, wherein heat is used in the hardening step d).

11. The method according to claim 1, wherein the discretized optical security microstructures have the width and the length from 80 μm to 50 cm and depth from 300 nm to 100 μm.

12. The method according to claim 1, wherein the discretized optical security microstructures have at least two different heights or different surfaces.

13. The method according to claim 4, wherein the substrate, preferably after the hardening step d), is laminated as a sandwich structure, wherein the substrate is a first layer, a second layer is made of a polymer or a resin and wherein said discretized optical security microstructures are between the substrate and the second layer.

14. The method according to claim 1, wherein each discretized optical security microstructure is separated from other such discretized optical security microstructure, wherein the separation distance is from 1 μm to 50 cm, preferably from 30 μm to 10 cm, most preferably from 80 μm to 1500 μm.

15. The method according to claim 1, wherein the shim is placing at least one discretized optical security microstructure on a relief on a substrate.

16. A shim for use in the method according to claim 1, said shim comprising a number of cavities and wherein the characteristic size of individual cavity, such as its width and the length, is from 80 μm to 50 cm and the depth of individual cavity is from 300 nm to 100 μm, wherein said cavities of the shim represent a discretized optical security microstructure representing diffractive or another optically active surface, preferably in a form of macro and/or micro relief, or simply curved shape with or without grating/hologram micro relief.

17. The shim according to claim 16, wherein each cavity have different size and/or surface.

18. The shim according to claim 16, wherein each cavity is separated from other cavities, wherein the separation distance is from 1 μm to 50 cm, preferably from 30 μm to 10 cm, most preferably from 80 μm to 1500 μm.

19. The shim according to claim 16, wherein it is made of preferably metal such as nickel.

20. The shim according to claim 16, wherein a depth z2 of the cavity is defined as a function g of the location on the surface of the shim:
z2=g(x,y),
wherein (x,y) are coordinates of a point of a cavity surface and z2 is measured in the direction normal (perpendicular) to said surface.

21. The shim according to claim 16, wherein said one or more cavities of the shim are a negative of said discretized optical security microstructure or are a positive of said discretized optical security microstructure.
